(19) United States
(12) Patent Application Publication
(10) Pub. No.: US 2013/0001390 A1
(43) Pub. Date: Jan. 3, 2013

(54) FLOW-THRU MOUNTING DEVICE AND ASSOCIATED SYSTEMS AND METHODS

(76) Inventors: Thomas Frost, Wappingers Falls, NY (US); Peter J. McGrath, Lindenhurst, NY (US); Leonardo Campanile, Brooklyn, NY (US); Frank Bubenik, Lodi, NJ (US); William G. Kinlen, Thornwood, NY (US)

(21) Appl. No.: 13/170,412

(22) Filed: Jun. 28, 2011

(51) Int. Cl. F16M 13/00

(52) U.S. Cl. 248/288.11; 248/274.1

(57) ABSTRACT

Systems and methods for making and using a flow-thru mounting device are described herein. The mounting device can include an adjustable fastening device and a flow-thru bracket, which is coupled to the fastening device. The fastening device may include a first contact surface near a first end of the fastening device and a second contact surface near a second end of the fastening device. The fastening device can be adjusted so that a user selectively increases and/or decreases the distance between the first and second contact surfaces. In this manner, the user can secure the mounting device to an object, such as a transformer. The flow-thru bracket can be configured to receive a mating component of a flow-thru. Accordingly, the mounting device can receive a flow-thru and attach that flow-thru at one or more locations on or within a transformer box. Other embodiments are described.

### FIELD

This application relates generally to safety equipment for use with power cables, such as buried power cables. More specifically, this application relates to systems and methods for making and using a mounting device that is capable of holding a flow-thru apparatus and attaching the flow-thru apparatus to an object, such as a transformer.

### BACKGROUND

Underground residential and industrial electrical distribution systems can include several high-voltage power cables that are buried in a trench. One end of each buried cable is generally connected to a loadbreak elbow which, in turn, plugs into a bushing to electrically connect the cable to a transformer. In this manner, the high voltage from the electrical cables can be stepped down by the transformer to a lower voltage before being supplied to an end user's electrical system.

Before working on, replacing, or testing a transformer or the various buried power cables that are connected to the transformer, a technician de-energizes the transformer and unplugs one or more of the loadbreak elbows (and corresponding power cables) from the transformer's bushings. In some cases, the technician then plugs the elbows that were unplugged from the transformer into conventional loadbreak portable flow-thru apparatus (or flow-thru).

A flow-thru may perform a variety of functions. For instance, a flow-thru can serve as a means for parking an energized or de-energized high-voltage underground cable at the transformer in order to bypass that transformer by feeding electricity through to another device. A flow-thru may also be used as a means to test and ground a parked cable in order to allow a technician to safely work on the cable or the transformer. Furthermore, while the transformer or cable is being worked on, a flow-thru can also be used to protect an elbow that has been unplugged from the transformer from dust, debris, water, and moisture.

### SUMMARY

This application relates to systems and methods for attaching a flow-thru apparatus to an object, such as a transformer. In particular, this application discusses systems and methods for making and using a flow-thru apparatus mounting device. The mounting device can include an adjustable fastening device and a flow-thru bracket, which is coupled to the fastening device. The fastening device may include a first contact surface near a first end of the fastening device and a second contact surface near a second end of the fastening device. The fastening device can be adjusted so that a user selectively increases and/or decreases the distance between the first and second contact surfaces. In this manner, the user can secure the mounting device to an object, such as a transformer. The flow-thru bracket can be configured to receive a mating component of a flow-thru. Accordingly, the mounting device can receive a flow-thru and attach that flow-thru at one or more locations on or within a transformer box.

### BRIEF DESCRIPTION OF THE DRAWINGS

The following description can be better understood in light of the Figures, in which:

FIG. 1A shows a front perspective view of some embodiments of a flow-thru mounting device and a flow-thru apparatus;

FIG. 1B shows a side perspective view of some embodiments of a conventional flow-thru.

FIG. 2 shows a back perspective view of some embodiments of the flow-thru mounting device;

FIG. 3 shows a side perspective view of some embodiments of the flow-thru mounting device in which the device comprises a flow-thru bracket that is positioned to hold a flow-thru substantially perpendicular to a length of the mounting device;

FIG. 4 shows a perspective view of some embodiments of the flow-thru mounting device in which the flow-thru bracket is pivotally attached to an adjustable fastening device;

FIG. 5 shows a side perspective view of some embodiments in which the flow-thru mounting device comprises a plurality of flow-thru brackets;

FIG. 6 shows a side perspective view of some embodiments in which the flow-thru mounting device is fastened within a transformer box;

FIG. 7 shows a cross-sectional view of some embodiments in which the flow-thru mounting device comprises a spreading mechanism;

FIGS. 8A and 8B each show a schematic view of some embodiments in which the flow-thru mounting device comprises a clamping mechanism; and

FIG. 9 shows a flow chart depicting some embodiments of a method for using the flow-thru mounting device.

The Figures illustrate specific aspects of the described flow-thru mounting devices and methods for making and using such mounting devices. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices. Moreover, the Figures may show simplified or partial views, and the dimensions of elements in the Figures may be exaggerated or otherwise not in proportion for clarity.

### DETAILED DESCRIPTION

The following description supplies specific details in order to provide a thorough understanding. Nevertheless, the skilled artisan would understand that the described flow-thru mounting devices and associated methods of making and using the mounting devices can be implemented and used without employing these specific details. Indeed, the mounting devices and associated methods can be placed into practice by modifying the illustrated devices and methods and can be used in conjunction with any other apparatus and techniques conventionally used in the industry. For example, while the description below focuses on methods for making and using the mounting devices to hold one or more flow-thru apparatus, the mounting devices can be used to hold one or more insulated parking bushings, grounded parking bushings, junctions with one or more tap units, and similar devices. Additionally, while the description below focuses on using the mounting device with a transformer, the mounting device can be used with any other suitable object.

In addition, as the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

Some embodiments of the flow-thru mounting devices and associated methods of making and using these devices with transformer boxes are described herein and illustrated in the Figures. Inside the transformer box of pad-mounted transformers, one or more parking stands for receiving a flow-thru are permanently secured adjacent to (e.g., above) a corresponding bushing on an interior wall. When a user (e.g., a technician) works on such transformers, the user may place a flow-thru in one of the parking stands and then park an elbow from a cable that has been unplugged from the transformer into the flow-thru. In some instances, the cable may be too short to allow its elbow to be plugged into the flow-thru that is held in the receptacle near the bushing. In such instances, it may require a difficult and/or time-consuming procedure to properly park and isolate the elbow. Indeed, to properly park an elbow that is connected to a cable that is too short to reach the flow-thru in the parking stand, a portion of the cable may need to be exhumed and an extension may need to be spliced therein. Accordingly, where the cable is too short to allow the elbow to be parked in a flow-thru that is received in a standard parking stand, downstream recipients and electrical feeders may be out of power for an extended period of time. Additionally, the parking procedure (e.g., the splicing in of new cable) may become quite costly.

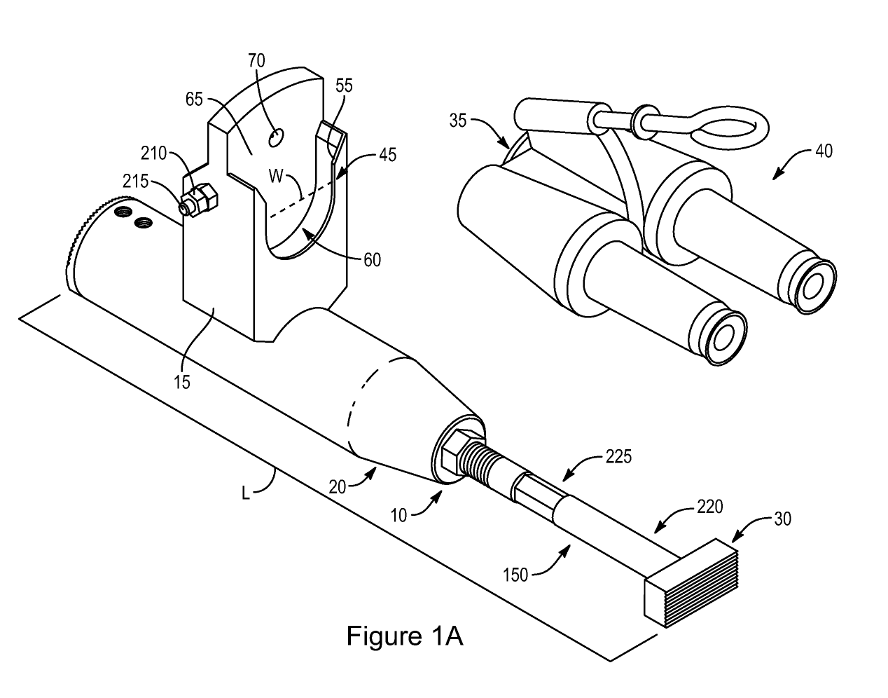

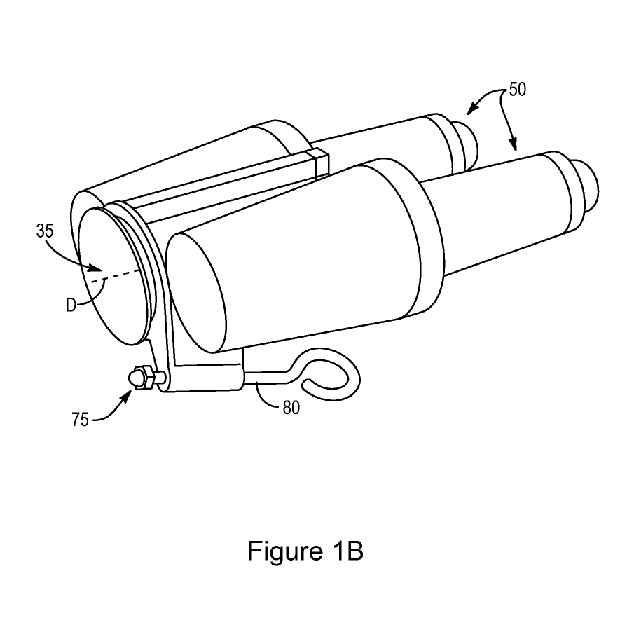

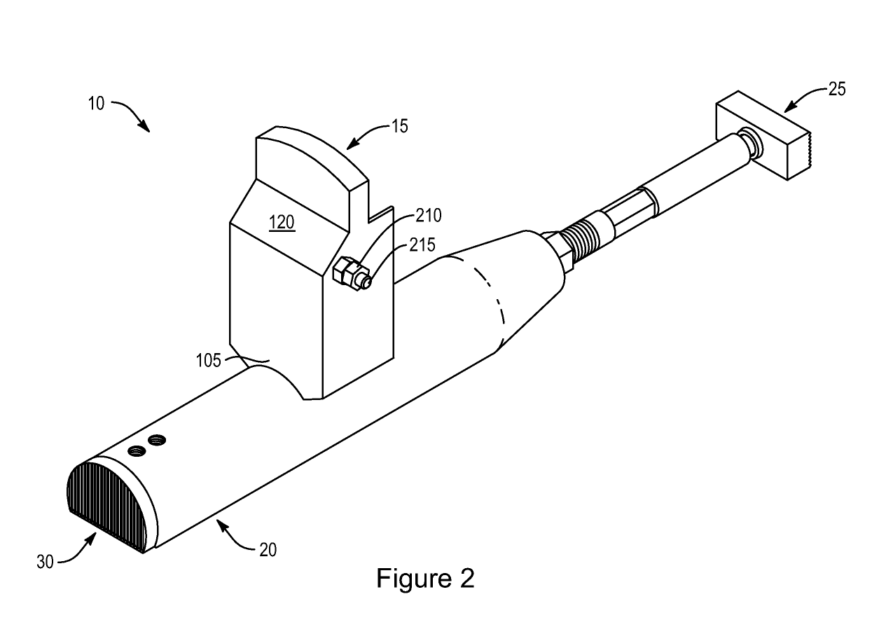

As shown in the Figures, a mounting device can be used to secure a flow-thru to a transformer in a position that allows an elbow to be parked in that flow-thru where the elbow's cable is too short to be parked in a flow-thru that is received in a standard parking stand. IN particular, FIGS. 1A and 2 show some embodiments in which the flow-thru mounting device 10 comprises a flow-thru bracket 15, an adjustable fastening device 20, a first contact surface 25, and a second contact surface 30.

The flow-thru bracket 15 can be configured to selectively and slidably receive and release a mating component 35 of a conventional flow-thru 40, as shown in FIGS. 1A and 1B. The flow-thru bracket may be configured to receive and release a mating component from a universal flow-thru, a vertical flow-thru 40, a horizontal flow-thru, an insulated parking bushing, a grounded parking bushing, and a junction with one or more tap units.

FIG. 1A shows some embodiments where the flow-thru bracket 15 can comprise a slot 45 configured to slidably receive the mating component 35 (shown in FIG. 1B). In these embodiments, the slot 45 can have any shape that allows it to slidably receive the flow-thru's mating component. Indeed, the slot can be substantially U-shaped, V-shaped, square-shaped, rectangular shaped, polygonal, or irregularly shaped. By way of illustration, FIG. 1A shows the configurations where slot 45 can be substantially U-shaped. Thus, where the mating component 35 has a perimeter that is substantially circular, the mating component can be received within the slot so that the flow-thru can be rotated with respect to the bracket. This ability to rotate the flow-thru may allow the flow-thru to be adjusted so that a tap unit 50 can be moved to allow the elbow on a short cable to reach the tap unit.

FIG. 1A shows some embodiments where the slot 45 can have a front rim 55 that defines an opening 60 having a width W that is narrower than a diameter D of the mating component 35 of the flow-thru 40 (shown in FIG. 1B). The slot optionally has a back rim or a back plate, as shown in FIG. 1A where the slot 45 comprises a back plate 65. Accordingly, when the mating component of the flow-thru is slidably received within the slot, the mating component can be sandwiched between the back plate 60 and the front rim 55.

Where the flow-thru bracket 15 comprises a back plate 65, the back plate can be configured to receive the flow-thru's mating component 35. By way of example, FIG. 1A shows that the back plate 65 can optionally define a recess 70. In this example, the recess can serve any suitable function, including receiving the tip 75 of a hold-down bolt 80 that extends from the flow-thru 40. In this manner, the recess and the hold-down bolt can function together to selectively lock the flow-thru to the flow-thru bracket.

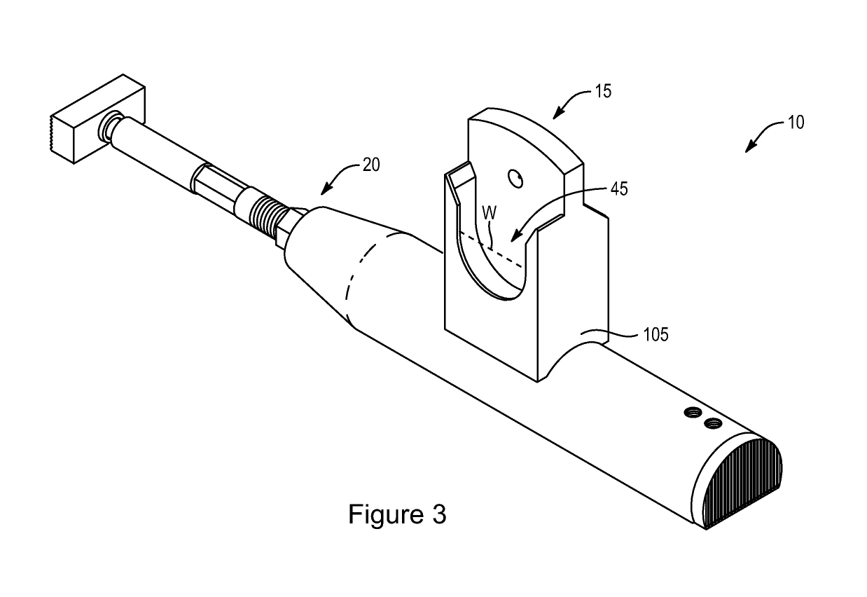

The flow-thru bracket 15 can be attached to the adjustable fastening device 20 in any suitable orientation that allows the bracket to hold the flow-thru 40 so that the user can properly park an elbow in that flow-thru. In some configurations, FIGS. 1A and 2 shows that the flow-thru bracket 15 can be coupled to the fastening device 20 so that the width W of the slot 45 runs substantially perpendicular to the length L of the fastening device. In other configurations, however, FIG. 3 shows that the width W of the slot 45 runs substantially parallel with the length L of the fastening device 20.

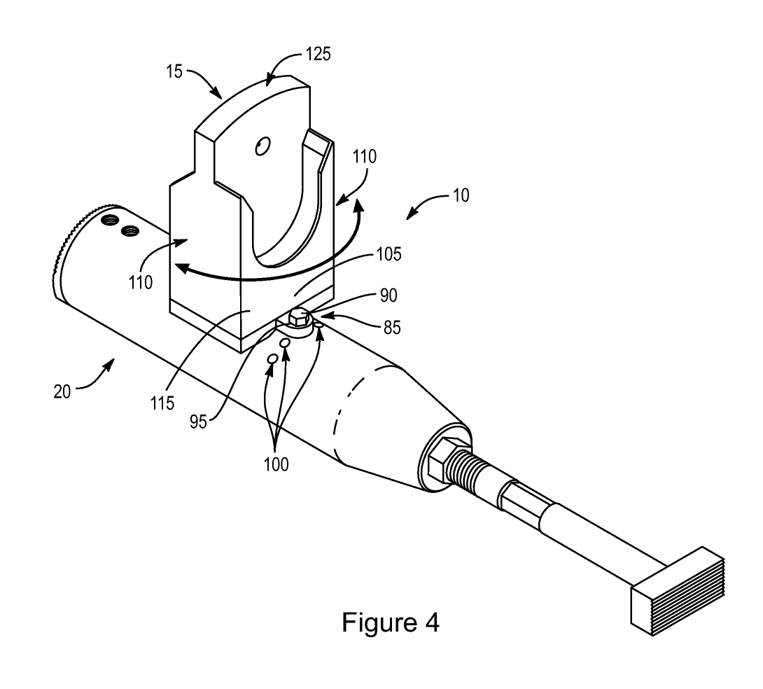

The width W of the slot 45 can run at any suitable angle to the length L of the lateral axis of the fastening device 20. Thus, the flow-thru bracket 15 can be permanently fixed or be movably fixed to the fastening device. For example, FIG. 4 shows embodiments where the flow-thru bracket 15 is optionally pivotally connected to the fastening device 20. In such embodiments, the bracket can pivot any suitable amount with respect to the fastening device. Indeed, in some configurations, the flow-thru bracket can pivot through a range of motion less than about 45 degrees. In other configurations, the flow-thru bracket can pivot through a range of motion less than about 90 degrees. In still other configurations, the flow-thru bracket can pivot through a range of motion less than about 180 degrees. In yet other configurations, the flow-thru bracket can pivot through a range of motion less than about 360 degrees. In still other configurations, the flow-thru bracket can spin more than 180 degrees.

Where the flow-thru bracket 15 pivotally attaches to the fastening device 20, the flow-thru bracket can be configured to rotate freely or to comprise a locking mechanism that is configured to selectively stop and release the bracket's pivotal movement. By way of example, FIG. 4 shows a locking mechanism 85 that can comprise a pin 90 that can be extend through an opening 95 in the flow-thru bracket 40 into an opening 100 in the fastening device 20.

Any portion of the flow-thru bracket 15 can be connected to the fastening device 20, provided the flow-thru bracket is positioned on the fastening device 20 so that a user can insert the mating component 35 of the flow-thru 40 into the bracket's slot 45 when the fastening device is frictionally attached to an object (such as a transformer). For example, the base 105, a lateral side 110, front side 115, back side 120, or top side 125 of the flow-thru bracket can be attached to the fastening device. FIGS. 1A and 2 show some configurations where the base 105 of the flow-thru bracket can be attached to the fastening device 20.

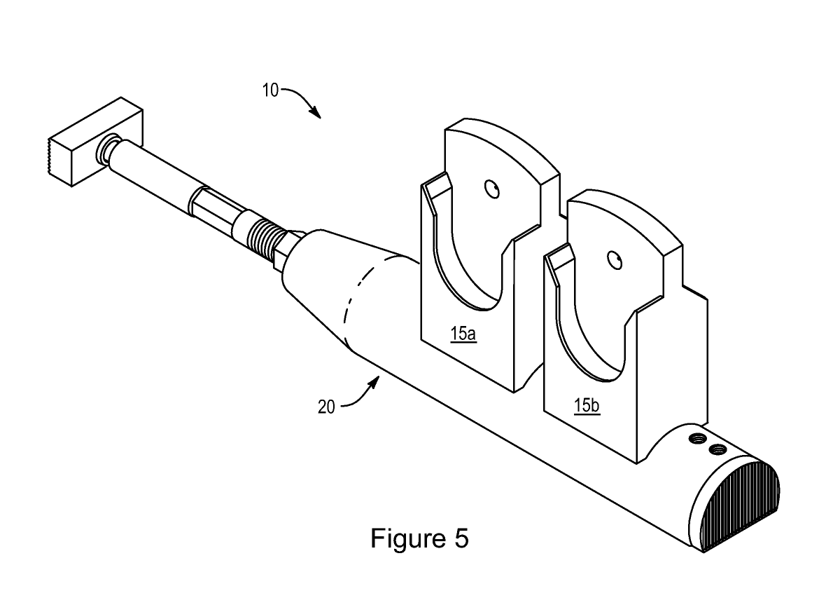

FIGS. 1A and 2 show some embodiments in which the mounting device 10 comprises one flow-thru bracket 15. The mounting device 10 can have any suitable number of flow-thru brackets, including 2, 3, 4, 5, 6, or more. Indeed, FIG. 5 shows some embodiments in which the mounting device 10 comprises two flow-thru brackets 15a and 15b.

The fastening device 20 can be configured to allow it to increase and/or decrease the space between the first 25 and second 30 contact surfaces in order to frictionally secure the mounting device 10 to an object. Thus, in some embodiments, the fastening device can comprise any spreading device that forces the first 25 and second 30 contact members apart so that the contact members are able to apply pressure to opposing surfaces of one or more objects, thereby holding the fastening device in place. In some embodiments, the fastening device can comprise more than one spreading device.

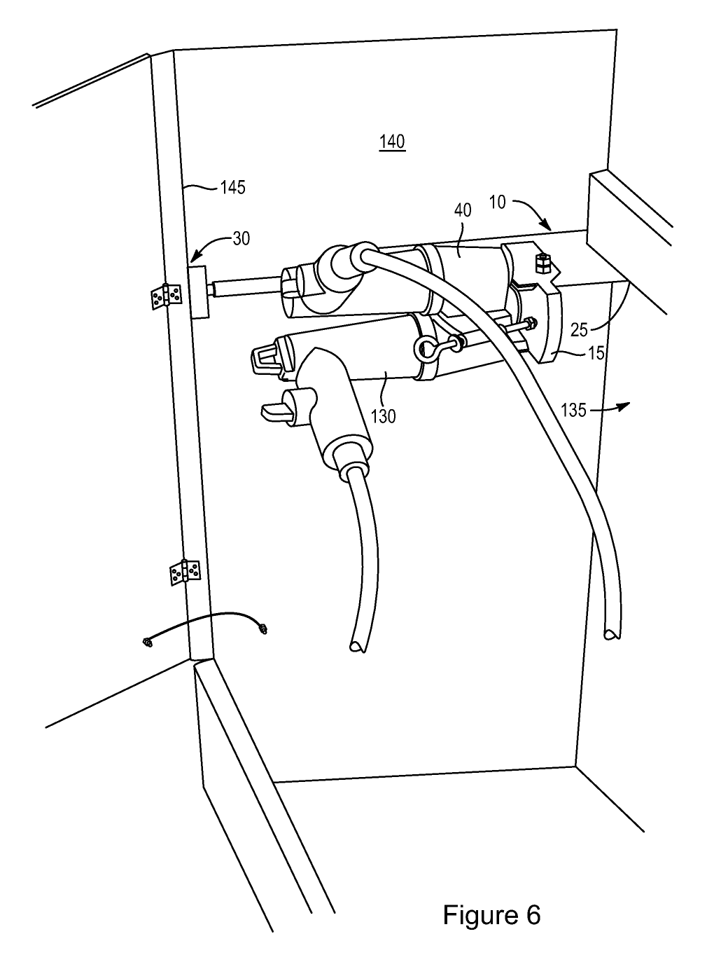

When it contains a spreading mechanism, the fastening device can be attached between any suitable opposing surfaces that safely allow the user to park an elbow 130 (shown in FIG. 6) in a flow-thru 40 held by the mounting device 10. For instance, the mounting device can be secured into a place where the first and second contact surfaces abut opposing sides of a door frame (e.g., opposing jambs), the ceiling and floor of a transformer box, two internal walls of the transformer box, and/or any other suitable surfaces. FIG. 6 shows some configurations where the first contact surface 25 can be frictionally engaged with a first wall 135 of the transformer box 140, while the second contact surface 30 can be frictionally engaged with a portion of the transformer box's door jamb 145. Some examples of spreading mechanisms include an extension mechanism that has an extension member that is adjustably connected to a support structure, a bar spreader, a one-handed bar spreader, a pipe spreader, a one-handed pipe spreader, a cam spreader, a telescoping spreader, a hydraulic spreader, and a scissor-jack spreader.

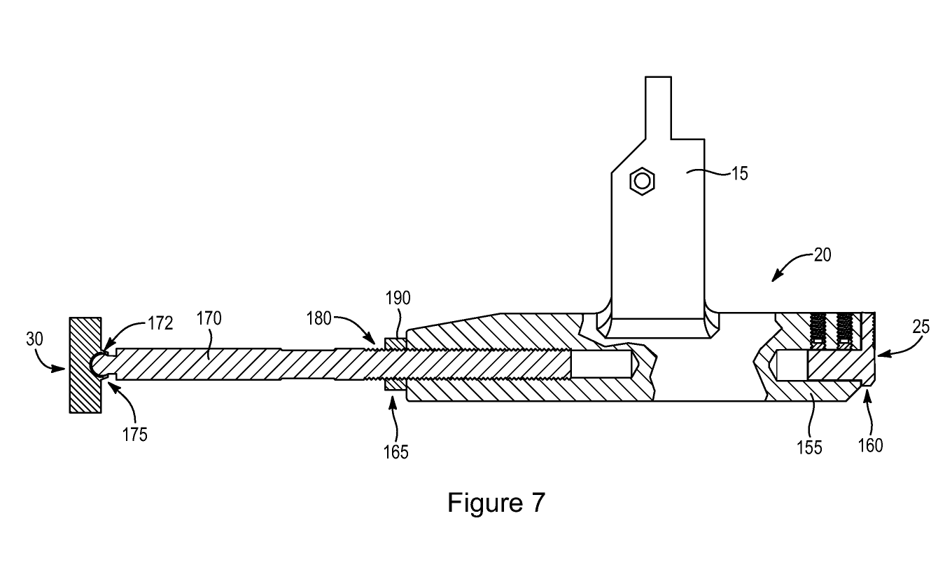

FIGS. 1A and 2 show some embodiments in which the fastening device 20 comprises an extension mechanism 150. The extension mechanism can be configured to allow the fastening device to increase the distance between the first 25 and second 30 contact surfaces to secure the fastening device between two substantially opposing surfaces. In this regard, FIG. 7 shows some embodiments in which the fastening device 20 comprises a support structure 155 with a first end 160 and a second end 165, wherein the first contact surface 25 is disposed near the first end. FIG. 7 further shows that the extension member 170 adjustably extends from the support structure's second end 165, wherein the second contact surface 30 is disposed near a first end 175 of the extension member 170. Accordingly, in such embodiments, when the user selectively adjusts the amount of the extension member that extends laterally past the second end of the support structure, the overall distance between the first and second contact surfaces changes (e.g., is increased and/or decreased).

Where the fastening device 20 comprises a support structure 155 and an extension member 170, they can be adjustably connected to each other. Thus, the support structure 155 and the extension member 170 can be threadingly coupled with each other. FIG. 7 shows some embodiments where the support structure 155 and the extension member 170 are threadingly coupled to each other, allowing them to be adjusted with respect to each other to increase and/or decrease the space between the two contact surfaces 25 and 30. In FIG. 7, the extension member 170 comprises threads 180 on a portion of its outer surface and the support structure 155 comprises corresponding threads 185 on a portion of its inner surface (e.g., nut 190). Thus, as the extension member is twisted in a first direction (e.g., counterclockwise), the distance between the first and second contact surfaces increases. In contrast, when the extension member in this example is twisted in a second direction (e.g., clockwise), the distance between the first and second contact surfaces decreases.

In some configurations, the extension member can comprise any component that facilitates the threading process. For example, the extension member can comprise a plurality of flattened surfaces that are configured to receive a wrench, a thumbwheel, and/or a pin that extends through a hole that extends through the extension member (e.g., substantially perpendicular to the longitudinal axis of the extension member). By way of illustration, FIG. 1A shows the shaft 220 of the extension member 170 can comprise a plurality of flat surfaces 225 that are sized, shaped, and positioned to receive the open end of a wrench (not shown).

Where the fastening device 20 comprises a spreading mechanism (such as extension mechanism 150), the spreading mechanism can spread the distance between the first contact surface 25 and the second contact surface 30 to any suitable length that allows the fastening device to force the contact surfaces against two opposing (or nearly opposing) surfaces in order to secure the mounting device to an object (e.g., a transformer box). Indeed, in some embodiments, the fastening device can increase the distance between the first and second contact surfaces to be as much as about 3 meters. In other embodiments, the fastening device can increase the distance between the first and second contact surfaces to be as much as about 1.5 meters. In still other embodiments, the fastening device can increase the distance between the two contact surfaces to be as much as about 1 meter. In yet other embodiments, the fastening device can increase the distance between the two contact surfaces to be as much as about 0.5 meters.

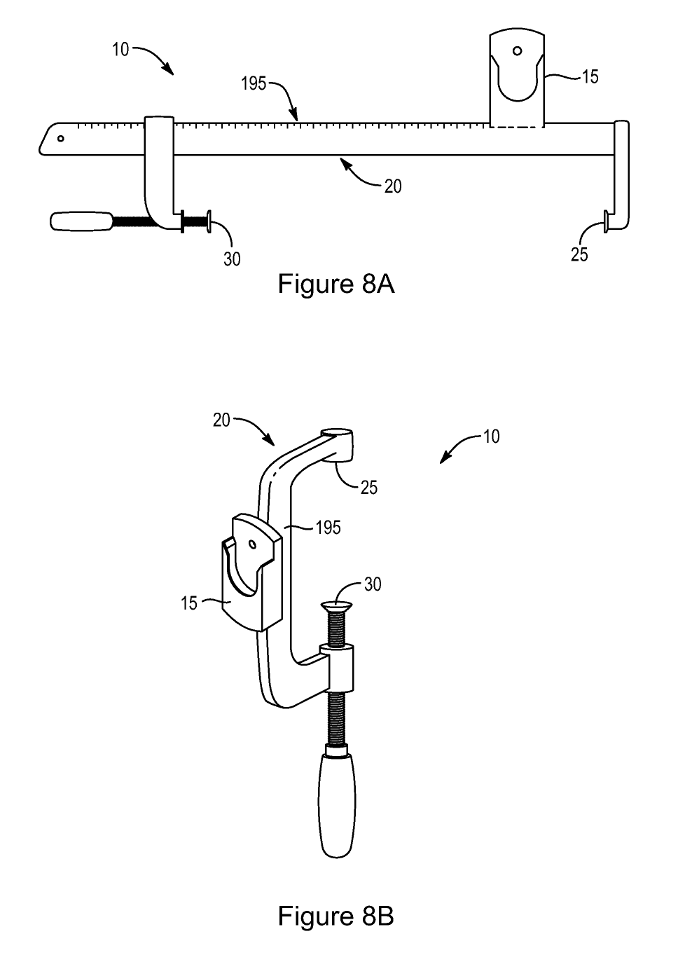

In other embodiments, the fastening device can comprise one or more clamping devices that contract to serve the same function as the spreading device. The clamping device can be configured to selectively force the first 25 and second 30 contact surfaces towards each other so as to pinch an object between the contact surfaces to frictionally attach the mounting device to that object. The fastening device can be attached to any suitable object. For example, the fastening device can clamp to a portion of a transformer box's door frame (e.g., the lintel, one of the jambs, or the sill), an object in a transformer box (e.g., a bracket), or to any other suitable object. Examples of clamping mechanisms including a pipe clamp, a one-handed pipe clamp, a bar clamp, a one-handed bar clamp, a screw clamp, a C-clamp, a spring clamp, a cam clamp, or any similar device. By way of example, FIGS. 8A and 8B show that the fastening device 20 can comprise a clamp 195 (e.g., a bar clamp and a C-clamp respectively) having the flow-thru bracket 15 attached thereto in any suitable orientation.

The clamping mechanism can allow the space between the first contact surface 25 and the second contact surface 30 to be any suitable length that allows the fastening device to pinch an object between the two contact surfaces in order to secure the mounting device 10 to that object. In some embodiments, the fastening device can adjusted so that the distance between the first and second contact surfaces is less than about 2 meters. In other embodiments, the fastening device can be adjusted so that the distance between the first and second contact surfaces is less than about 1 meter. In still other embodiments, the fastening device can be adjusted so that the distance between the two contact surfaces is less than about 0.5 meters. In yet other embodiments, the fastening device is configured so that the distance between the two contact surfaces can be less than about 0.25 meters.

The first 25 and second 30 contact surfaces can be configured to frictionally engage one or more objects so as to secure the mounting device 10 to that object. In one example, the first and/or second contact surfaces comprise a gripping surface, such as a roughened surface, a surface with a plurality of teeth, a knurled surface, an abrasive surface, a surface comprising a material with a high coefficient of friction (e.g., a rubber), or any combination thereof. FIG. 2 shows some embodiments in which the first contact surface 25 comprises a knurled surface 200.

The first 25 and second 30 contact surfaces can be attached to the fastening device 20 in any known manner. In some configurations, one or both the contact surfaces can be integrally connected or pivotally connected to the fastening device. For example, the contact surface can be integrally formed with, be welded to, be bonded to, or be mechanically fastened to (e.g., bolted, riveted, or otherwise mechanically fastened to) the fastening device. In another example, the first 25 and/or second 30 contact surfaces can be pivotally attached to the fastening device 20 through the use of a ball joint, a pivot pin, a lazy Susan bearing, or any other suitable pivot joint. FIG. 1A shows some embodiments in which the second contact surface 30 is pivotally attached to the extension member 170 (e.g., via a ball joint 172, which is shown in FIG. 7). In such embodiments, the pivotal attachment may allow the extension member to twist while the second contact surface does not. Additionally, where one or both of the contact surfaces are attached to the fastening device through the use of a ball joint or a similar pivotal connector, a large portion of the area of one or both contact surfaces can contact an object when the portions of the object that are contacted by the contact surfaces are not completely parallel to each other.

In some embodiments, the mounting device optionally comprises a ground terminal. The ground terminal can serve as an attachment point for a wire or cable that is electrically grounded. The ground terminal can comprise one or more clips, nuts and bolts, clamps, and/or other components that allow the terminal to pinch or otherwise retain a ground wire. By way of illustration, FIGS. 1A and 2 show some configurations in which the ground terminal 205 comprises at least one nut 210 and bolt 215 that are configured to pinch a ground wire (not shown).

The mounting device 10 can be configured with material that allows it to function as described. In some embodiments, the mounting device includes one or more metals (e.g., aluminum, iron, steel, etc.), ceramics, resins, polymers, resinoids, or combinations thereof. In other embodiments, the mounting device materials comprise one or more electrically conductive materials that allow the mounting device to be grounded (e.g., by connecting a ground wire to the mounting device or by securing the mounting device to an object that is grounded).

The mounting device 10 can be made in any manner that forms the structures described. By way of example, the mounting device can be formed through a process involving molding, extruding, casting, cutting, etching, grinding, stamping, drilling, welding, bonding, tapping, dying, screwing, twisting, and/or bending.

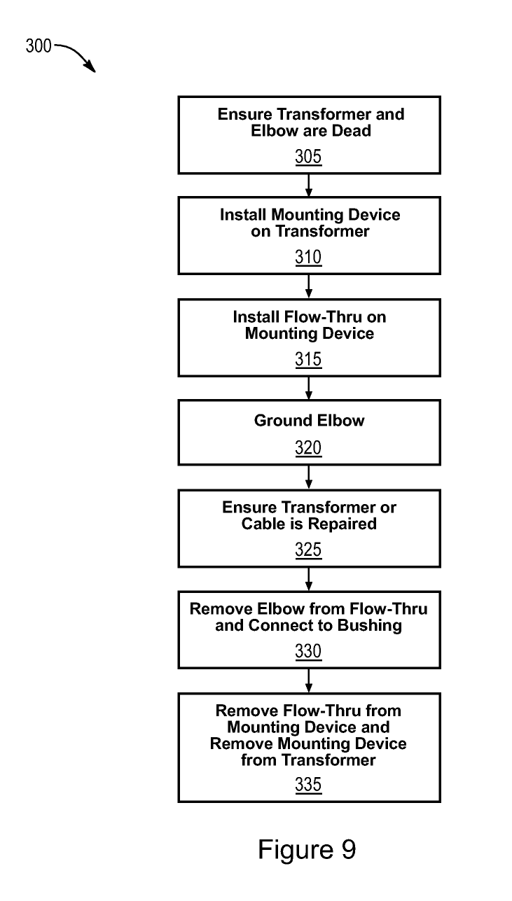

The mounting device 10 can be used in any known manner. FIG. 9 illustrates some embodiments of one method 300 for using the mounting device. The method shown in FIG. 9 can be modified by rearranging, adding to, removing, and modifying the various portions of the method. At box 305, FIG. 9 shows the method 300 can begin by ensuring that the transformer is de-energized and that any elbow 130 that is unplugged from the transformer is tested dead (e.g., by switching power off and/or using a potential detector). Box 310 shows the method continues as the user installs the flow-thru mounting device 10 to the transformer (e.g., by tightening the mounting device comprising a spreading mechanism between the transformer's opposing door jambs). In so doing, the user ensures that the mounting device is tightly secured to the transformer (or other object) so that there is no chance of slippage.

Box 315 shows that the method continues as the user installs the flow-thru 40 on the newly installed flow-thru mounting device 10. The user may use a hot stick (or any other suitable equipment) to remove the elbow 130 from its bushing and plug the elbow (shown in FIG. 6) into the flow-thru 40.

Box 320 shows that once the elbow is plugged in to the flow-thru 40, the user can ground the elbow by connecting a ground wire that is connected to the transformer's ground to the ground terminal 205. Next, after the cable or transformer has been tested, repaired, or replaced, box 325 shows that the user ensures that the transformer or cable has been properly tested or repaired. At that point, box 330 shows the user can remove the elbow 130 from the flow-thru 40 and replace it on the bushing (not shown) of the transformer. Box 335 shows that the user can then remove the flow-thru from the mounting device 10 and remove the mounting device from the transformer.

The mounting device 10 contains several helpful features. First, as discussed above, the mounting device allows a user to safely and securely place a flow-thru 40 in a variety of places. Accordingly, if a cable is too short to allow its corresponding elbow 130 to be plugged into a flow-thru that is disposed in a parking stand that is permanently attached within the transformer box 140, the user can easily use the mounting device to secure a flow-thru to a more convenient location in the box. In this manner, the user can safely hold and park the cable and elbow without needing to lengthen the cable or to perform some other time-consuming procedure. Thus, the mounting device can greatly reduce the amount of time that a transformer needs to be down in circumstances in which an associated cable is too short to reach a flow-thru disposed in one of the transformer's permanent parking stands.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. A flow-thru mounting device, comprising:
an adjustable fastening device having a first contact surface and a second contact surface, wherein the fastening device is able to selectively retain and change a distance between the first and second contact surfaces to retain and release the fastening device from an object; and
a flow-thru bracket configured to receive a mating component of a flow-thru apparatus, wherein the flow-thru bracket is coupled to the adjustable fastening device.

2. The device of claim 1, wherein the fastening device comprises a spreading mechanism in which the first and second contact surfaces substantially face away from each other.

3. The device of claim 1, wherein the fastening device comprises a clamping mechanism in which the first and second contact surfaces substantially face towards each other.

4. The device of claim 1, wherein the flow-thru bracket is pivotally attached to the fastening device.

5. The device of claim 1, wherein a back plate of the flow-thru bracket faces substantially perpendicular to a length of the fastening device.

6. The device of claim 1, wherein a back plate of the flow-thru bracket faces substantially towards the first contact surface or the second contact surface.

7. The device of claim 1, wherein the first and second contact surfaces each comprise a gripping surface.

8. The device of claim 1, further comprising a ground terminal that is attached to the flow-thru apparatus mounting device.

9. A flow-thru mounting device, comprising:
an elongated support structure having a first end and a second end, wherein a first contact surface is disposed near the first end;
an extension member that extends from the support structure's second end, wherein the extension member comprises a second contact surface disposed near a first end of the extension member, and wherein the extension member is adjustably connected to the support structure so the extension member adjusts with respect to the support structure to selectively change a distance between the first and second contact surfaces; and
a flow-thru bracket configured to receive a mating component of a flow-thru apparatus, wherein the flow-thru bracket is coupled to the support structure.

10. The device of claim 9, wherein the first and second contact surfaces substantially face away from each other.

11. The device of claim 9, wherein the first and second contact surfaces substantially face towards each other.

12. The device of claim 9, wherein the second contact surface is pivotally attached to the extension member's first end.

13. The device of claim 9, wherein the extension member is treadingly attached to the support structure.

14. The device of claim 13, wherein the extension member comprises a plurality of flat surfaces that are positioned between the support structure's second end and the extension member's first end.

15. The device of claim 9, further comprising a ground terminal that is attached to the flow-thru apparatus mounting device.

16. The device of claim 9, wherein the flow-thru bracket is pivotally attached to the support structure.

17. A flow-thru mounting device, comprising:
an elongated support structure having a first end and a second end, wherein a first contact surface is disposed near the first end;
an extension member threadingly connected to the support structure so as to extend from the support structure's second end, wherein the extension member comprises a second contact surface that is pivotally attached to a first end of the extension member, wherein the second contact surface substantially faces away from the first contact surface, and wherein the extension member twists with respect to the support structure to selectively change a distance between the first and second contact surfaces; and
a flow-thru bracket configured to receive a mating component of a flow-thru apparatus, wherein the flow-thru bracket is coupled to the support structure.

18. The device of claim 17, wherein the flow-thru bracket is pivotally attached to the support structure.

19. The device of claim 17, wherein the flow-thru bracket comprises a recess configured to receive a tip of a hold down bolt from the flow-thru apparatus.

20. The device of claim 17, wherein the first and second contact surface each comprise a gripping surface.

21. The device of claim 17, further comprising a ground terminal that is attached to the flow-thru apparatus mounting device.

22. A flow-thru mounting system, comprising:
a flow-thru mounting device, comprising:
an adjustable fastening device having a first contact surface and a second contact surface, wherein the fastening device is able to selectively retain and change a distance between the first and second contact surfaces to retain and release the fastening device from an object; and
a flow-thru bracket configured to receive a mating component of a flow-thru apparatus, wherein the flow-thru bracket is coupled to the adjustable fastening device; and
a flow-thru apparatus containing a mating component selectively captured by the flow-thru bracket.

23. The system of claim 22, wherein the second contact surface is pivotally attached to the second end of the adjustable fastening device with a ball joint.

24. The system of claim 22, wherein a back plate of the flow-thru bracket faces substantially perpendicular to a length of the fastening device.
